(19) United States
(12) Patent Application Publication
(10) Pub. No.: US 2009/0109441 A1
(43) Pub. Date: Apr. 30, 2009

(54) Method and apparatus for enhancing waveguide sensor signal

(76) Inventor: Nile Hartman, Duluth, GA (US)

Correspondence Address: William M. Brown;nGimat Co., 53153 Peachtree Industrial Blvd., Atlanta, GA, 30341-2107, US

(21) Appl. No.: 12/300,463

(22) PCT Filed: May 8, 2007
(86) PCT No.: PCT/US07/11071

§ 371 Date: Nov. 12, 2008

Related U.S. Application Data
(60) Provisional application No. 60/800,878, filed on May 16, 2006.

(51) Int. Cl. G02B 6/00; G01B 9/02

(52) U.S. Cl. 356/477; 385/12

(57) ABSTRACT

A detection system for a first specific material is provided by which an interferometer, having a reference waveguide segment and a test waveguide segment, is enhanced. The test waveguide segment carries a second capture material for specifically capturing said first specific material that may be present in a fluid specimen. Capture of the first specific material is detected by an interference pattern produced by combining coherent light beams passing through the waveguide segments. To enhance by orders of magnitude the detection limits of the test, the waveguide segments are subjected to an alternating or pulsed electrical or magnetic fields. This same signal is fed to a lock-in amplifier that is associated with computational means by which the interference pattern is interpreted. The invention further includes a waveguide system in which capture of the first specific material is detected by fluorescence. Detection of the fluorescent signal is enhanced relative to noise by subjecting the waveguide segment to alternating or pulsed electrical or magnetic signal.

The present invention is directed to waveguide sensors, in one such example as an interferometer systems, and more particularly to methods and apparatus via alternating or pulsed electrical or magnetic signal for enhancing detection of chemical and biological materials.

### BACKGROUND OF THE INVENTION

Waveguide sensors, including waveguide sensors based on fluorescence and interferometers are known in the art. Herein, while waveguide sensors are described primarily with respect to interferometer sensors, but the principles are not limited to such and apply to other waveguide sensors as well. Where differences in sensor systems from interferometer sensors exist, these are noted.

Optic interferometers and their uses for detecting various materials, including biomolecular materials have been described, e.g., U.S. Pat. Nos. 5,623,561 and 6,545,759, the teachings of each being incorporated herein by reference.

The sample sensing areas of such interferometers comprise a pair of waveguide segments on a substrate, each waveguide segment having an optically transmitting core that has a thickness somewhat less than the wavelength of the light passed therethrough, and each waveguide segment consisting of a thin, optically transparent substrate coating. One of the waveguide segments is a reference segment; this reference segment has an exposed outer surface. A parallel sample or test waveguide segment also has an exposed outer substrate surface, except bound to this exposed outer surface of the test waveguide segment is a capture material intended to bind with at least some specificity to a target (or captured) material. For example, the substrate-bound material may be biomolecular, such as an antibody, antigen, or DNA or RNA probe intended to subsequently bind specifically with, respectively, a target antigen, a target antibody, or target complementary DNA or RNA segment.

Parallel laser, (monochromatic and coherent) light beams are concurrently passed through the reference waveguide sample segment and the sample waveguide segment, and, after passing through the parallel waveguide segments, the beams of the two waveguide segments are combined. This combining of the beams, produce an interference pattern in the combined beam. When the target biomolecular material binds to the surface-bound or “capture” biomolecular material, the interference pattern is changed or shifted because of binding of the target biomolecular material to the bound material on the surface of the sample waveguide segment; the shifted interference pattern indicates the presence of the target biomolecular material in the sample and the magnitude of the shift is related to the quantity of material bound to the surface.

Because of the small size of an interferometer and the close proximity of the two parallel waveguide segments, the two waveguide segments are conveniently continuously exposed to the same fluid sample, potentially containing the target biomolecular material. The fluid sample may contain extraneous material that may affect the surfaces of the parallel waveguide segments; however, as both waveguide segments are exposed to the same material, any effects of this extraneous material are effectively cancelled.

While detection of target biomolecular materials using optical interferometers has been demonstrated, sensitivity with designs produced to date has been found to be insufficient for a number of practical applications. For example, it may be desirable to test a water specimen for presence of a molecule of a pathogen, such as a molecule unique to a particular virus or to bacteria. The virus or bacteria may be present in the water in such very low concentrations that the current art fails to yield a detectable response. Accordingly, a sample of the water exposed to the interferometer may result in binding of only a very small amount of the target biomolecule to the sample waveguide substrate surface. In such case, signal levels may be well below background noise.

Thus, there exists the need to enhance interferometric detection of biomolecular material by several orders of magnitude.

### SUMMARY OF THE INVENTION

In accordance with a general aspect of the invention, the signal-to-noise ratio (SNR) of a waveguide sensor is enhanced by subjecting the waveguide sensor to an alternating or pulsed electric or magnetic field that is normal to the direction of the light path through the sensor and applying the same alternating or pulsed electrical or magnetic signal to a phase-locked amplifier associated with the detection and computational system that interprets the waveguide sensor signal.

In accordance with one aspect of the invention, the signal-to-noise ratio (SNR) of a waveguide with a biomolecular detection system may be enhanced by several orders of magnitude by subjecting the waveguide to an alternating or pulsed electric or magnetic field that is normal to the direction of the light path through the waveguide and supplying the same alternating or pulsed electrical or magnetic signal to a phase-locked amplifier associated with the detection and computational system that interprets the waveguide signal. When the biomolecular or capture material exhibits a net electrical charge, SNR enhancement is achieved by subjecting the sensing section of the waveguide to an alternating or pulsed electrical field. If the biomolecular or capture material of interest does not exhibit a net electrical charge, it is convenient to bind the sensing material to the surface of a magnetically attractable nanoparticle that is tethered to the waveguide surface via a linker molecule, in which case SNR enhancement is achieved by subjecting the waveguide segments to an alternating or pulsed magnetic field gradient. The magnetically attractable particles only need to reside within the evanescent field associated with the guided optical wave.

In accordance with a further aspect of the invention, when the target molecule is contained within or on the surface of a cell or virus, the cell or virus is preferably fragmented by ultrasound before the specimen is exposed to the interferometer. Because bacterial cells typically are much larger than the evanescent field of a guided optical wave, much of the cellular material is does not interact with the guide wave. By fragmenting the large cellular unit, this allows material contained within the virus or cell, such as DNA, to be exposed to the interferometer, or allows more cell surface or viral surface target molecule to bind to the capture molecule. An enhancement of an order of magnitude is possible simple by breaking the cell into 10 pieces.

### BRIEF DESCRIPTION OF THE DRAWINGS

FIG. 1 is an illustration of an interferometer (prior art) such as one type of waveguide that might be used in the present invention.

FIG. 2 is an illustration of the substrate surface having a substrate-bound capture biomolecules shown capturing complementary target biomolecules.

FIG. 3 is an illustration of a substrate surface in which the capture molecule is linked to the substrate surface to a magnetically susceptible nanoparticle.

FIG. 4 is a schematic illustration of a specimen cell in which a specimen is exposed to the waveguide surfaces of an interferometer, the interferometer being subjected to a normal electrical or magnetic field.

FIG. 5 is a schematic illustration of a detection system utilizing the specimen cell of FIG. 4.

FIG. 6 is a Phase Modulated Output of an ITO Waveguide.

FIG. 7 is a graph showing interferometric phase shift due to application of a varying magnetic field gradient to the surface of an optical waveguide with attached magnetic nanoparticles.

FIG. 8 is a sensor including a waveguide, such as may be the sample waveguide section of an interferometer, that is used for detecting ionic chemical species.

### DETAILED DESCRIPTION OF CERTAIN PREFERRED EMBODIMENTS

It is known that biomolecules, such a proteins and DNA segments, typically exhibit a net electrical charge, and this property has been used, for example, to enhance diffusion kinetics through the application of an electric field. In conjunction with the an integrated optic interferometric biosensor, such as that described in above referenced U.S. Pat. No. 5,623,561, this property can be used to provide a powerful signal processing tool, making possible a phase-locked detection method relying on phase modulation using the actual capture molecule. This approach would have the advantage of discriminating between signal due to binding of a specific target material from phase noise due other sources such as micro-refractive index inhomogeneities within a sample solution.

### Technical Overview:

The phased-locked detection approach relies on the attachment of layer of capture molecules exhibiting a net electrical charge. For example, the binding of a monolayer of a typical 150-kDalton protein capture molecule to the surface of an optical waveguide can alter the effective mode index of a properly designed optical waveguide by as much as 10⁻³ and more. Furthermore a relative change of only a few Angstroms in the shape of an attached biomolecule or its relative position with respect to the waveguide surface can induce effective mode index changes of 10⁻⁵ to greater than 10⁻⁴ (based on a shift of only 3 Angstroms from the unperturbed position of a bound layer). The application of an electric field normal to a waveguide surface is expected to be capable of shifting the relative position of a bound protein layer by a few Angstroms. A typical protein can exhibit a net electric charge equivalent to 3 electrons (3e). Calculations indicate electric field strengths as small as 10⁻² volts/micrometer can induce displacements of 3 Angstroms. Note the effective displacement can either increase or decrease, depending on E-field direction. For a 15 mm path length interferometer, index changes of 10⁻⁵ to 10⁻⁴ would corresponds to phase shifts of 0.45π to 4.5π radians. Phase shifts of this magnitude would be more than sufficient for implementing phase locked detection methods capable of detecting the binding of a very small number of highly specific target molecules.

Similarly, the attachment of a monolayer of specific sDNA sequence (which normally exhibits a net negative electric charge) serving as a capture or sensing layer to the surface of the sensing channel of a waveguide interferometer using a linker molecule can produce index changes of greater than 10⁻⁴ (assumes DNA is only 3 Angstroms thick). A change in position by a monolayer of the capture DNA segments relative to the waveguide surface of only 1 Angstrom can induce an effective index mode change of approximately 3×10⁻⁵, corresponding to a phase shift of 1.34π for a 15 mm pathlength.

Phase shifts of this magnitude provide the option for active signal processing in the case of the highly sensitive integrated waveguide interferometers. Phase-locked detection can be implemented through the application of an alternating electric (AC) field normal to the waveguide surface. The AC field modulates the phase velocity of the guided wave through interaction with electrically charged capture molecules attached to the waveguide surface. As a result, the optical output signal from the interferometer is intensity modulated at the same frequency as the AC field. Using the applied AC field as the reference signal for a phase sensitive detection via a lock-in amplifier, the amplification and narrow bandwidth filtering of the lock-in amplifier can be utilized to detect very weak phase signals due to binding of a conjugate molecule such as a protein, a specific DNA sequence, a virus or pathogen. This signal processing approach is particularly advantageous as the actual parameter that performs the recognition step is the same parameter that is being modulated. This form of phase-locked detection can provide signal-to-noise ratio enhancements of approximately three to four orders of magnitude, thus offering much lower detection sensitivity levels, much shorter response time and, potentially, further reduction of false positives/negatives.

The use of an electric field to modulate the relative position of bound biomolecules with respect to the waveguide surface and correspondingly, the phase velocity of a guided wave also offers the potential for other signal characterization methodologies. The magnitude of an induced phase shift will be proportional to amount of bound target molecule. By application of a ramped D.C. voltage, it is expected that the binding rate of the target molecules can be dramatically enhanced, thus offering an approach to speeding up the kinetics of the process and reducing detection time.

Somewhat analogous to “stripping voltametry” where an applied voltage greater than some threshold level causes ions to be pushed away from an ionic electrode, it is possible to use the electric field to decouple bound conjugate molecules (target molecules) from the surface tethered capture molecules. The signal change observed with decoupling would be directly proportional to the number of bound target molecules. This approach is likely to reduce errors due to non-specific binding, as the weakly bound non-specific species will be more easily moved away from the surface. Thus a weak field could be used to remove non-specifically bound species that would be washed away prior to application of an electric field of sufficient strength to decouple the bound conjugate molecules. Similarly with the application of higher field strength, the bound target molecules could also be removed. In the case of an interferometer waveguide, each time the weak field is used to remove non-specific bound materials, either a similar field would be applied on the reference channel or the phase signal would be re-zeroed.

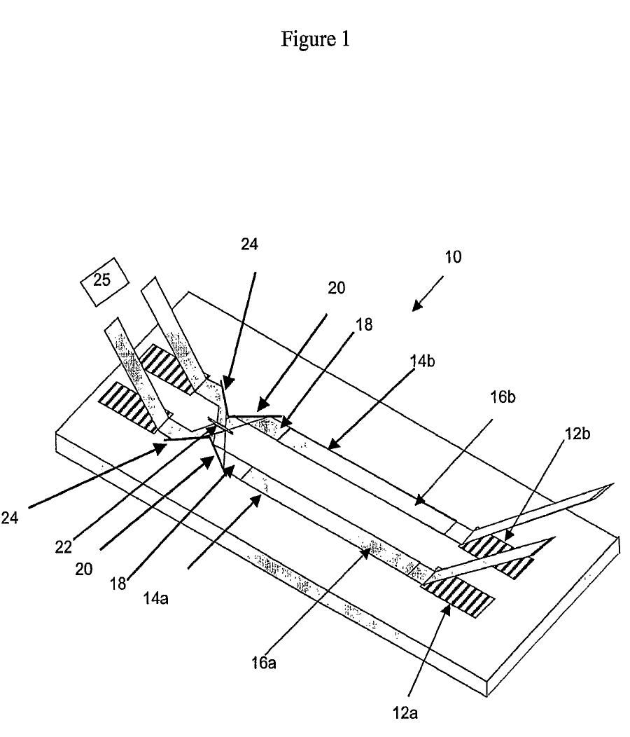

Illustrated in FIG. 1 is a schematic of a typical interferometer 10. This and other prior art interferometer designs may be used in the present invention. The interferometer itself is prior art and not part of the present invention. Light from a diode laser (not shown) is directly injected by grating coupling elements 12a and 12b into the planer waveguide segments 14a and 14b, one of these 14a representing a reference waveguide segment and the other a sample or test waveguide segment 14b. The light beams entering the waveguide segments 14a and 14b are in phase; however, due to surface difference on an exposed surface 16a and 16b of each waveguide segment 14a and 14b, the light exiting the waveguides segments through segments 18 are out of phase. The light beams are reflected off of first surfaces 20 of total internal reflecting (TIR) mirrors, and, by passage through a Fresnal Beam Splitter 22, are commingled as two combined light beams. Because the light in the two beams are coherent, interference patterns are produced when the beams are combined. The beams are reflected off of second surfaces 24 of the TIR mirrors and interference out patterns are detected by a charged coupled device (CCD) camera 25. The CCD camera 25 generates electrical signals according to the interference patterns, allowing computational analysis of the interference patterns.

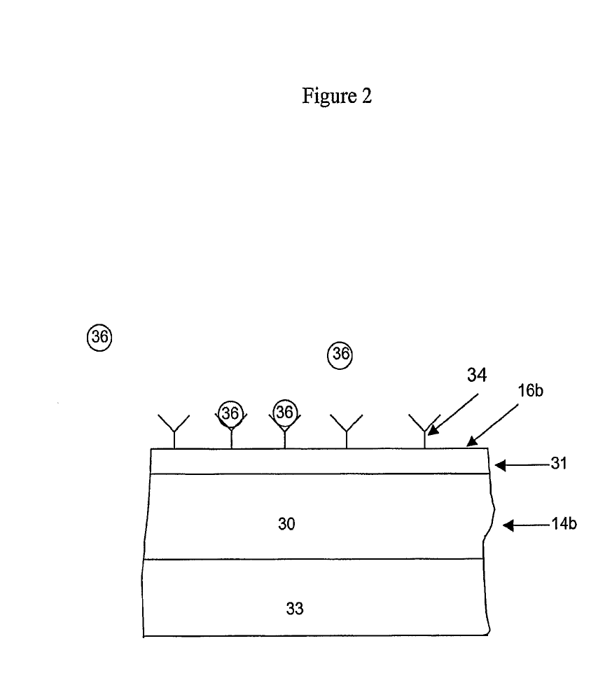

For detecting biomolecular material, the exposed surface 16b of the waveguide 14b typically has attached to it a biomolecule 34 that, with at least some specificity, binds to a biomolecule to be detected in a liquid to which the waveguide segments 14a, 14b are exposed. Thus, in FIG. 2, is illustrated a waveguide segment 16b comprising the waveguide core 30, a substrate 33 underlying the waveguide core, and the upper biocapture film 31 providing the exposed surface 16b of the test waveguide segment 14b. A plurality of capture biomolecules is represented in FIG. 2 as a plurality of antibody molecules 34. Because waveguide segment surface 16b has bound antibodies 34, while reference waveguide segment surface 16a does not, an interference pattern change occurs due to selective binding to 16b when the beams from the waveguide segments 14a and 14b are combined. Some of the antibody molecules 34 have captured antigens 36, for which the capture antibodies 34 are specific. This further changes the speed of the light beam (phase) passing through waveguide segment 14b and thus changes the interference pattern that is observed by the CCD camera.

Many biomolecular conjugates, such as the antibody-antigen 34, 36 conjugates of FIG. 2, carry an electrical charge. This electrical charge provides a basis for electrical field signal enhancement in accordance with the present invention.

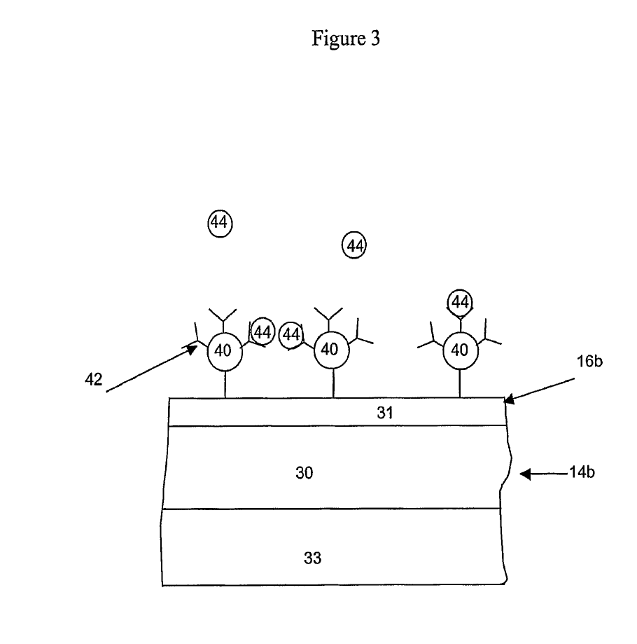

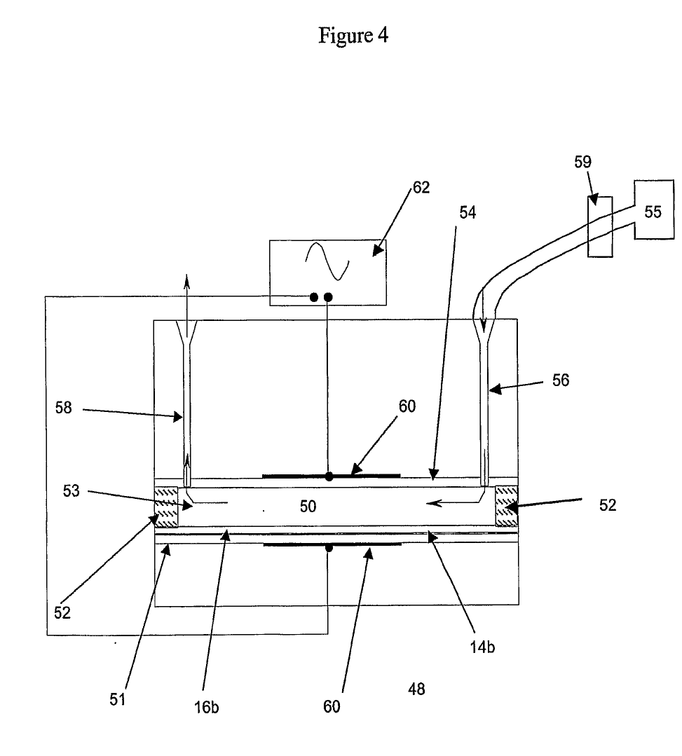

There are biomolecular conjugates and sensing chemistries of interest that do not carry an electrical charge or an electrical charge sufficient for meaningful amplification in accordance with the present invention. In FIG. 3 is illustrated a waveguide surface 16b′ in which magnetically susceptible nanoparticles 40 are bound to the substrate, first complementary (capture) biomolecules 42 are bound to the nanoparticles, and second complementary biomolecules 44 are captured by some of the first complementary (captured) biomolecules 42. The magnetic properties of the nanoparticles provide the basis for magnetic field signal-to-noise enhancement in accordance with the present invention. Nanoparticles of materials such as cobalt iron oxide (CoFexOy) are sufficiently magnetic for amplification in accordance with the invention. Binding of nanoparticles to substrate surfaces 16b is described, for example, in M. A. M. Gijs, “Magnetic Bead Handling on Chip: New Opportunities for Analytical Applications,” Microfluid Nanofluid, Vol. 1, pp 22-40, 2004. Binding of capture molecules 44 to nanoparticles is described, for example, in C. C. Berry and A. S. G. Curtis, “Functionalization of Magnetic Nanoparticles for Applications in Biomedicine,” J Physics D: Applied Physics, Vol. 36, pp R198-R206, 2003. Illustrated in FIG. 4 is a fluidics specimen cell 48 in which a specimen is exposed to the waveguide segment surfaces of an interferometer. For purpose of discussion, this cell will be discussed with reference to the sample or test waveguide segment 14b having surface 16b with (directly or indirectly) bound capture molecules. However, it is to be understood that the reference waveguide segment 14a will be exposed to the same liquid specimen and the same alternating or pulsed electrical or magnetic field. A test cell reservoir 50 is defined in FIG. 4 by the waveguide segment surface 16b that is carried on a non-conducting substrate 51, such as silicon, a pair of end dams 52, sidewalls 53 and an upper plate 54. Liquid specimen from source reservoir 55 is fed to the reservoir 50 through input conduit 56, and after being exposed to the surface 16b, the liquid exits through exit conduit 58. Associated with the illustrated cell in FIG. 4 between the source reservoir 55 and the cell reservoir 50 is an ultrasound unit 59 which may optionally be employed to break up larger particles, such as whole bacteria or whole viruses, and thereby allow more antigens to be captured by the capture molecules 34 on the substrate surface. Below the waveguide segment 14b, and just above the upper plate 54 are a pair of electrodes 60 by which an alternating or pulsed electrical or magnetic field supplied from source 62, normal to the light path through the waveguide segment 16b, is applied to the waveguide surface 16b and the capture or capture/captured biomolecular material 34 or 34/36 on the waveguide surface. The electrical or magnetic field provides the basis for the orders of magnitude signal enhancement of the present invention is achieved.

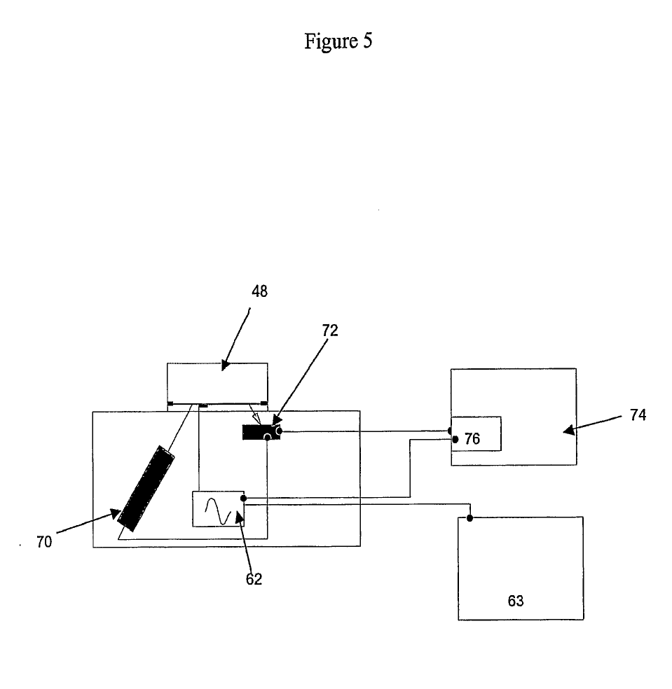

Illustrated in FIG. 5 is a schematic illustration of a detection system utilizing the specimen cell 48 of FIG. 4. A thermo-electric cooled (TEC) laser 70 provides light to the waveguide segments of the fluidics cell 48, and a detection array 72 including the CCD camera 25 (FIG. 1). The signal from the source 62, which is powered by a power supply 63, is sent to computational means, such as a personal computer 74. Associated with the computational means 74 is a lock-in amplifier 76. The lock-in amplifier 76 receives the same alternating or pulsed signal from source 62 that is used to enhance the signal in fluidics cell 48. Because the same alternating or pulsed signal that is used to enhance signal in fluidics cell 48 is fed to the lock-in amplifier 76, detection clarity is enhanced because the Lock-in amplifier behaves as a very narrow band electronic filter, thus any phase change signals with frequencies outside the lock-in bandwidth are excluded thus weak signal changes are more easily seen as the noise floor is reduced. For signal enhancement, alternating current or pulsed frequencies will typically be in the range of between about 0.1 Hz to about 500 Hz. Electrical field strengths to which the waveguide segments 16a and 16b will typically be between about 0.01 to and about 0.1 volts/micrometer. If the modulation is based on magnetic nanoparticles, magnetic field gradients of 1000 to 10,000 Gauss/millimeter will typically be required.

### EXAMPLES

### Guided Wave Phase Modulation by E-Field and Magnetic Field Applications

For the present inventions, phase modulation of a guided optical wave by application of an electric field to the hydrated surface of an optical waveguide with attached biomolecules has been demonstrated as well as by application of a magnetic field gradient to the surface of an optical waveguide with attached magnetic nanoparticles (MNPs).

### E-Field Modulation of an Attached Biomolecule.

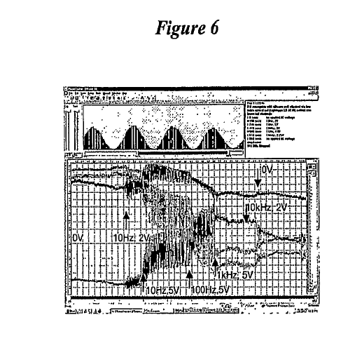

To demonstrate phase modulation of a guided optical wave by applying an electric field and moving attached biomolecules relative to the waveguide surface, an indium-tin oxide (ITO) waveguide was used. Thus the conductive ITO waveguide formed one electrode while a second electrode was formed through a metal film attached to the top of a thin cell used to confine aqueous solutions onto the waveguide surface. A bio film was produced by absorbing avidin to the waveguide surface. A sinusoidal AC (alternating current) source was used to apply an electrical signal to the electrodes of the waveguide-cell combination. Results are shown in FIG. 6 where signals of varying voltage amplitude and AC frequency were tested. The interferometric output clearly shows a modulated response correlated with the AC frequency and AC voltage amplitude. These experimental results demonstrate biomolecules attached to a waveguide surface can moved sufficiently with respect to an optical waveguide and the corresponding evanescent field associated with a guided optical wave so as to modulate the output of a waveguide interferometer.

### Phase Modulation Using Attached Magnetic Nanoparticles (MNPs).

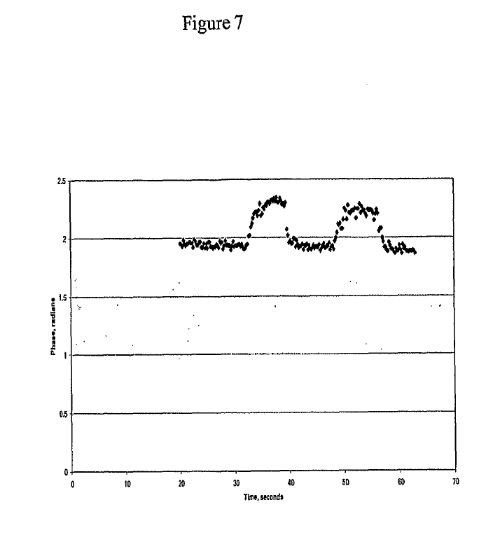

For the magnetic field experiments, amine-functionalized MNPs from Corpuscular Inc. with a diameter of 250 nm were attached to the surface of an optical waveguide using a long chain avidin-biotin linker. To demonstrate response to varying magnetic field, two magnets were positioned relatively close to a waveguide surface and moved with respect to the waveguide surface so as to introduce a field gradient. The resulting interferometric response is illustrated in FIG. 7. In this case, the magnet was moved approximately 4 to 5 millimeters from the surface and then returned to its original position. At distances of more than 4 millimeters, no additional response was observed and a maximum phase shift of approximately 0.4 radians resulted. In actual practice, as the gap increased beyond 4 to 5 millimeters, the signal began to return to the original base line level. Over a displacement range of 0 to 4 millimeters, the phase response clearly correlated to the displacement of the top magnet relative to the waveguide surface. Upon returning the magnet to its original position, the phase returned to it's original base level as well. Positioning the lower magnet near the waveguide, thereby reversing magnetic field direction, resulted in a phase shift in the opposite direction. These results clearly demonstrate magnetic nanoparticles attached to a waveguide surface can be moved small distances relative to the waveguide surface and the evanescent field of a guided optical wave so as to introduce a phase delay in a guided wave and correspondingly a change in the interference pattern in the case of a waveguide interferometer.

MNP or electrical charged species can be used to better detect large species that are primarily outside the evanescent field and to “weight” attached species. All capture materials have specific mechanical properties including elasticity. One measurement of elasticity is the spring constant. The larger the mass of a captured material, the slower the phase change response to the change in E or M. By using two or more frequencies, one can calculate the resulting weight and possible define other species or even discriminate live versus dead biomolecules.

### Waveguide Sensor-Phased Locked Detection Based on Fluorescence Measurements.

Waveguide sensors based on detection of a fluorescence signal from a captured antigen with an attached fluorescent label may also be used for phased locked detection and signal-to-noise (SNR) enhancement. In the case of waveguide sensors based on detection of a fluorescent signal, the guided optical wave serves as an excitation source. As in the interferometric sensing scheme, the surface of a waveguide is functionalized with a capture molecule, an antibody for example, and when exposed to a media containing a conjugate molecule, direct and specific binding of the conjugate to the functionalized waveguide surface will occur. Fluorescent-labeled antigens for such detection techniques are commercially available, e.g., labeled prostrate serum antigen (PSA). Detection of the binding step, however, requires a transduction step wherein a detectable signal results. One approach relies on the use of the use of the evanescent field from a guided wave of an appropriate wavelength to excite fluorescence in the bound conjugate or alternatively to use additional chemical reagents such as a fluorescent label that will specifically bind to the captured antigen. Similarly to the interferometric scheme the application of an electric can be used to push or pull a charged molecule towards or away from the waveguide surface. Again this is based on the fact that biomolecules such a proteins and DNA typically exhibit a net electrical charge, thus they respond to the presence of an electric field. The displacement of the fluorescent molecule or label molecule relative to the waveguide surface, causes a variation in the strength of the electric field associated with the guided wave and, correspondingly, the strength of the excitation signal seen by the fluorescent label or molecule. As a result, the fluorescence signal intensity varies with distance from the waveguide surface. By using an alternating or bipolar electric field, an AC intensity modulation may be introduced to the fluorescent signal, which offers the basis for a phased locked detection method with significant improvement in signal-to-noise ratio. The same AC signal used for fluorescent signal modulation will also serve as the reference signal to a lock-in amplifier, thus enabling phased locked detection. As in the interferometric approach, the locking amplifier behaves as a very narrow band electronic filter, excluding optical signals at frequencies other than the reference AC frequency, resulting in substantial improvement in SNR. This approach permits optical fluorescent signals buried in a noisy background to be readily detected because the noisy background is excluded.

The waveguide schematics shown in FIGS. 2 and 3 will also work for fluorescence detection sensors. The fluorescence is typically noted and quantified by optical detectors, such as CDT cameras. As detection is in accordance with the fluorescence generated, a reference waveguide is not needed, as in the case of an interferometer.

### Interferometric Sensing Based on Phase Locked Detection and Electrochemical Sensing Methods.

Similarly to the previously described phased locked detection of biological molecules using a waveguide interferometer, electrochemical reactions may also be utilized for specific detection of chemical agents or species in water. In this case, however, an electric potential between two electrodes is used to stimulate the electrochemical reaction. Somewhat similarly to an ion selective CHEMfet transistor, an insulating gate structure is exposed to an ionic solution. The surface charge density varies with surface association and dissociation of charge species resulting in the introduction of a phase change of the guided optical wave which may be detected interferometrically as previously noted. By the application of an AC electric potential, the charge density may be varied resulting in a corresponding phase modulation of the associated guided optical wave, thus providing the basis for phased locked detection and signal-to-noise ratio (SNR) enhancement.

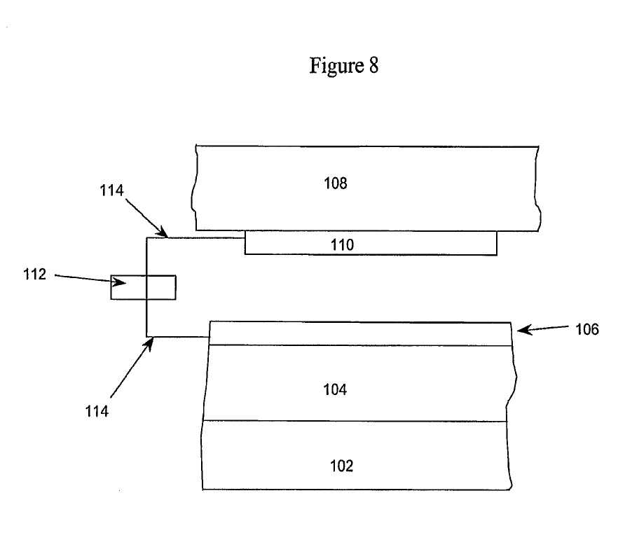

Illustrated in FIG. 8 is a sample interferometer cell 100 for detecting ionic compounds. On a substrate 102 is provided a waveguide core 104 through which the wave is guided and an ion specific membrane 106 on the upper surface of the waveguide core. For convenience of applying an electric field, the waveguide core 104 is formed of electrically conducting material. The cell has an upper wall to define, with the waveguide, a fluid passage 109. Along the upper wall is an electrode 109.

To attract a specific ion, e.g., a sodium ion for salinity determination, a DC electric field is applied between electrode 110 and waveguide core 104 from a source 112 through electrical connections 114. The source 112 further provides an AC current (Or additional pulsed DC current) superimposed on the DC current, and the signals generated are transmitted to a phase-locked detection system.

In this system the ion-specific membrane 106 serves as the capture material for capturing, upon application of an electrical field, specific ionic species.

Various features of the invention are set forth in the following claims.

What is claimed is:

1. A waveguide sensor system for detecting a specific first material, the system comprising,
a waveguide segment having an exposed surface, a second capture material associated with said exposed surface, said second capture material being capable of selectively capturing said first material, a source of coherent light and means for passing coherent light through said waveguide segment, means to expose said exposed surface of said waveguide segment to a fluid potentially containing said specific first material, whereby capture of said specific first material by said second capture material alters the phase velocity of said coherent light passing through said waveguide segment,
means to detect the alteration of the phase of coherent light passing through said waveguide segment occasioned by capture of said specific first material by said second capture material and to generate a detection signal in response to said capture,
a signal source of an alternating or pulsed electrical or magnetic signal,
means to expose said waveguide segment to said alternating or pulsed electrical or magnetic signal at least in part in a direction normal to the direction of coherent light through said waveguide segment and thereby enhance said detection signal relative to noise, and
computational means for receiving and interpreting said detection signal.

2. The waveguide system in accordance with claim 1 wherein said first specific material is a biomolecule and said second capture material is a biomolecule that forms a conjugate with said first specific material.

3. The waveguide system in accordance with claim 2 wherein said conjugate carries an electrical charge, whereby the detection signal may be enhanced by an alternating or pulsed electrical signal from said signal source.

4. The waveguide system in accordance with claim 2 wherein said first material is tagged with a fluorescent molecule whereby said conjugate fluoresces in response to said coherent light passing through said waveguide.

5. The waveguide system in accordance with claim 1 wherein said first specific material is an ionic species and said second capture material is specific to said ionic species.

6. The waveguide system in accordance with claim 1 further comprising magnetically susceptible nanoparticles associated with said second capture material, whereby a pulsed magnetic field enhances said detection signal relative to noise.

7. The waveguide system in accordance with claim 1 wherein said first specific material is a material found in a bacterium or a virus and said system further comprises means to fragment cellular or viral material in fluid prior to exposing said waveguide segment to said fluid.

8. The System of claim 1 wherein lock-in amplifier means are associated with said computational means, said lock-in amplifier means being in communication with said signal source for receiving said alternating or pulsed electrical or magnetic signal.

9. The system of claim 1 wherein said waveguide segment is a sample waveguide segment of an interferometric system, said interferometric system further comprising a reference waveguide segment.

10. An interferometric system for detecting a specific first material, the system comprising,
an interferometer comprising a pair of waveguide segments, one waveguide segment serving as a reference waveguide segment and one waveguide segment serving as a test waveguide segment, said test waveguide segment having an exposed surface and bound to said exposed surface, a second material comprising a capture material capable of capturing said first material to form a detectable composite material that comprises a conjugate of said first and second material, said detectable composite material being formed by or excitable by alternating or pulsed electrical or magnetic signals, a source of coherent light and means for passing coherent through said waveguide segments, means for combining light passing through said waveguide segments so as to produce an interference pattern, and means to detect said interference pattern and generate an interference electrical signal,
means to expose said exposed surfaces of said waveguide segments to a fluid potentially containing said specific first material,
a signal source of an alternating or pulsed electrical or magnetic signal,
means to expose said waveguide segments to said electrical or magnetic signal at least in part in a direction normal to the direction of light through said waveguide segments and thereby enhance the interference pattern produced combining light passed through said waveguide segments, and
computational means for receiving and interpreting said generated interference electrical signal.

11. The system according to claim 10 wherein said first specific material is a biomolecule.

12. The system according to claim 10 wherein said conjugate of said first and second materials carries an electrical charge, whereby the signal may be enhanced from an electrical signal from said signal source.

13. The system according to claim 10 wherein said bound material comprises said capture biomolecule and magnetically susceptible nanoparticles, whereby the signal may be enhanced from a magnetic signal from said signal source.

14. The system of claim 11 wherein said first specific material is found in a bacterium or a virus and said system further including means to fragment cellular or viral material in fluid prior to exposing said waveguide segments to said fluid.

15. The System of claim 10 wherein lock-in amplifier means are associated with said computational means, said lock-in amplifier means being in communication with said signal source for receiving said alternating or pulsed electrical or magnetic signal.

16. The system of claim 10 where spring constant and the response at two frequencies is used to determine the weight and frequencies of bound species.

17. The system of claim 10 wherein said first specific material is ionic and said second capture material is specific to said first specific material.

18. A waveguide sensor system for detecting a specific first material that is a portion of a larger biological material that has been fragmented to enhance detectability, the system comprising,
a waveguide segment having an exposed surface, a second capture material associated with said exposed surface, said second capture material being capable of selectively capturing said first material, a source of coherent light and means for passing coherent light through said waveguide segment, means to expose said exposed surface of said waveguide segment to a fluid potentially containing said specific first material within said larger biological material, whereby capture of said specific first material by said second capture material alters the phase velocity of said coherent light passing through said waveguide segment,
means to fragment said larger biological material within said fluid before exposing said exposed surface to said fluid,
means to detect the alteration of the phase of coherent light passing through said waveguide segment occasioned by capture of said specific first material by said second capture material and to generate a detection signal in response to said capture,
and
computational means for receiving and interpreting said detection signal.

19. The waveguide sensor system in accordance with claim 18 wherein said means to fragment said larger biological material fragments said material by ultrasound.
